(19) United States
(12) Patent Application Publication
(10) Pub. No.: US 2007/0087749 A1
(43) Pub. Date: Apr. 19, 2007

(54) METHOD, SYSTEM, APPARATUS AND COMPUTER PROGRAM PRODUCT FOR PLACING PILOTS IN A MULTICARRIER MIMO SYSTEM

(75) Inventors: Dumitru Mihai Ionescu, San Diego, CA (US); Balaji Raghothaman, San Diego, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION, Espoo (FI)

(21) Appl. No.: 11/463,920

(22) Filed: Aug. 11, 2006

Related U.S. Application Data
(60) Provisional application No. 60/707,761, filed on Aug. 12, 2005.

(51) Int. Cl. H04J 11/00

(52) U.S. Cl. 455/436; 370/208

(57) ABSTRACT

A method, system, apparatus and computer program product are provided for placing pilot symbols in an OFDM system using sets of multidimensional points having a structure that is derived from discernible expansions of generalized orthogonal designs. These sets of multidimensional points may be used to form pilot symbols on a two-dimensional frequency-time pilot symbol grid for sampling the flat fading process on various subcarriers of an OFDM MIMO system, transmit antennas, and OFDM symbols. The pilot information associated with the pilot symbols may be used to perform initial carrier synchronization and OFDM symbol timing while discerning between candidate base stations.

### CROSS-REFERENCE TO RELATED APPLICATIONS

The present application claims priority to U.S. Provisional Application No. 60/707,761, filed Aug. 12, 2005 entitled Method and Apparatus for Placing Pilots in a Multicarrier MIMO System, the contents of which are incorporated herein in their entirety.

### FIELD

Embodiments of the invention relate, in general, to communication systems and, in particular, to the placement of pilot symbols in an orthogonal frequency division multiplexing (OFDM) communication system.

### BACKGROUND

As wireless communication systems such as cellular telephone, satellite, and microwave communication systems become widely deployed and continue to attract a growing number of users, there is a pressing need to serve a large and variable number of communication subsystems transmitting a growing volume of data with a fixed resource such as a fixed channel bandwidth. Traditional communication system designs employing a fixed resource (e.g., a fixed frequency or a fixed time slot assigned to each user) have become challenged in view of the rapidly growing customer base.

Higher performance communication systems can operate by transmitting orthogonal signals over a channel. The orthogonal signals can be separated by a receiver using coherent (or matched) signal processing that relies on accurate knowledge of signal parameters such as channel gain, carrier frequency, carrier phase, and system timing. Such an aforementioned communication system is the orthogonal frequency division multiplexing (OFDM) communication system.

As an example of an OFDM communication system, a group of N bits of data from a signal source represented by the bit sequence {aᵢ}, i=0, . . . , (N−1) including data in digital format is mapped into a sequence of “constellation” points {Xᵢ}, i=0, . . . , (N−1) in the complex plane with real and imaginary components (i.e., the N bits of data are mapped into 2·N real numbers represented by the N complex signal points). The constellations of signal points are formed using conventional techniques that space the signal points of an information signal in the complex plane with sufficient distances between the mapped points. The extra factor of two in the 2·N real numbers recognizes that complex numbers are formed with two real components. The N complex points can be thought of as points in a “frequency domain.”

The N complex points are then mapped into a sampled time function with complex values {xᵢ}, i=0, . . . , (N−1) by performing an Inverse Fast Fourier Transform (IFFT) on the complex signal sequence {Xᵢ}. The complex-valued, sampled time function {xᵢ} has frequency components corresponding to the frequency components of the IFFT process. The sampled time function {xᵢ} is converted after adding the corresponding cyclic prefix into an ordinary, complex-valued, continuous time function x(t) by digital-to-analog conversion and filtering. The complex-valued signal x(t) is used to modulate a carrier waveform both in-phase and in quadrature, such as a 1.9 GHz carrier for cellular telephony or for other applications such as digital audio or video broadcasting.

The wideband signal transmitted to a receiver, such as a receiver for a mobile station, is processed in numerous steps and is degraded by unknown and random processes including amplification, antenna coupling, signal reflection and refraction, corruption by the addition of noise, and further corruption by frequency and timing errors caused by a motion of the receiver and unpredictable variations in the transmission path. These processing steps, which produce channel “dispersion,” result in intersymbol interference (ISI) from signal frames transmitted about a signal frame of interest, and from signal frames transmitted by neighboring cellular base stations (communicating with the mobile station) that simultaneously occupy the same channel bandwidth. The signal frames are then corrupted by dispersion mechanisms, and accidentally acquire the characteristics of the signal of interest.

To protect against ISI, a guard interval corresponding to a number of leading or trailing signal components is often inserted between successive signal frames. The guard interval is usually formed in cellular telephony systems by inserting a “cyclic prefix” at the beginning of each signal frame. A cyclic prefix is typically chosen to be a set of the last signal components of the signal frame, which extends the length of the signal frame at the front end by the chosen length of the cyclic prefix. Upon reception of the extended signal frame, the cyclic prefix (representing redundant signal information) is discarded. The addition of a cyclic prefix makes a signal robust to multipath propagation.

To allow a receiver of a mobile station, particularly in systems using orthogonal frequency division multiplexing, to reliably receive and detect the information in a signal frame (even with the insertion of a cyclic prefix), it is preferable to know the parameters of the channel such as the carrier frequency offset, channel gain and phase, and overall timing, all of which are generally unknown and varying at the receiver for reasons described above.

To compensate for unknown channel parameters, the transmitter inserts a set of pilot symbols that are continually transmitted to the receivers in fixed known frequency-time pattern positions using a known data sequence and known amplitude. In essence, the pilot symbols provide “training data” for the receiver. The pilot symbols allow the receivers to estimate the channel impulse response and timing down to the chip level, which is preferable for reliable identification and reception of an unknown data sequence, and can even be used to identify and extract multipath signal components.

The pilot symbols may be transmitted with an unmodulated sequence to reduce the signal search dimensionality and to accommodate variable acquisition times in the initial receiver frequency acquisition process. The pilot symbols can be shared by many users and can be transmitted with enhanced energy content. Since the pilot symbols occupy valuable channel resources and consume transmitter energy, a limited set of such pilot symbols is preferable.

The pilot tones, which are subcarriers used to transmit the pilot symbols, are typically inserted by each transmitter in a frequency-time pattern that specifies the pilot tone sequence that will be used, such as a frequency-time pattern as illustrated in FIG. 1, where an “X” represents a transmitted pilot tone. The pilot tones transmitted by one base station, however, can interfere with the pilot tones transmitted by another base station, typically by an adjacent base station. To reduce or avoid pilot tone interference, pilot tones for a contiguous group of base stations can be placed in random but fixed locations of a periodic frequency-time pattern commonly shared by all the base stations in the contiguous group. Other pilot tone placement strategies, such as patterns starting with Latin square sequences, have been used wherein the pilot tones of different adjacent base stations are regularly shifted in a parallel slope arrangement and have different initial displacement position values. For an example of the use of pilot tones in a multicarrier spread spectrum system, see European Patent Application No. EP 1148674A2 entitled “Pilot use in Multicarrier Spread Spectrum Systems,” to Laroia et al., priority date of Apr. 18, 2000 (hereinafter “Laroia et al.”), which is incorporated herein by reference.

An arrangement for an individual base station to preserve the quality of the reception process by inserting pilot tones at specified frequency locations across the channel is described by R. Negi and J. Cioffi, in “Pilot Tone Selection for Channel Estimation in a Mobile OFDM System,” IEEE Transactions on Consumer Electronics, vol. 44, no. 3, pp. 1122-1128, August 1998 (hereinafter “Negi et al.”), and by S. Ohno and G. B. Giannakis, in “Optimal Training and Redundant Precoding for Block Transmission with Application to Wireless OFDM,” IEEE Transactions on Communications, vol. 50, no. 12, pp. 2113-2123, December 2002 (hereinafter “Ohno, et al.”), which are incorporated herein by reference. Based on the findings of the aforementioned references, pilot tones are equally spaced and are transmitted with equal power to provide enhanced channel parameter estimates by using, for instance, a mean square error criterion. For example, for a channel with 512 frequency components, 11 pilot tones may be inserted at frequency locations such as 0, 50, 100, 150, . . . , 500 to allow sufficiently accurate estimation of the channel characteristics by the receiver. Channel characteristics at intermediate frequency locations between the pilot tones are estimated in the receiver by interpolation.

For frequency division duplex (FDD) systems (i.e., systems that operate simultaneously on separate channels for both transmission and reception), L. Ping, in “A Combined OFDM-CsCDMA Approach to Cellular Mobile Communications,” IEEE Transactions on Communications, vol. 47, no. 7, pp. 979-982, July 1999 (hereinafter “L. Ping”), which is incorporated herein by reference, addresses deployment of cellular telephony systems with multiple, adjacent cells by wrapping several OFDM symbols into a cyclic prefix CDMA superframe. This approach adds an additional guard interval (at the CDMA level) to the already available guard intervals embedded in the OFDM symbols, thereby reducing the spectral efficiency of the composite signal. It is not necessary to pre-encode the signal into OFDM symbols, as long as the cyclic prefix CDMA is used. Thus, after the CDMA layer signal is detected at the receiver and its cyclic prefix is removed, it is not necessary to have additional guard intervals for the embedded OFDM symbols because the effect of multipath propagation has already been compensated for. Inasmuch as L. Ping employs the CDMA layer for insertion of a cyclic prefix, the reference fails to address the selection of pilot tones in the environment of wireless communication systems such as multicellular OFDM communication systems.

The estimation of carrier frequency offset is further addressed by M. Speth, S. Fetchel, G. Fock and H. Meyr in “Digital Video Broadcasting (DVB): Framing, Structure and Modulation for Digital Terrestrial Television,” ETSI EN 300744, v1.4.1, January 2001 (hereinafter “Speth, et al.”), and in a case study entitled “Optimum Receiver Design for OFDM-Based Broadband Transmission—Part II: a Case Study,” IEEE Transactions on Communications, vol. 49, no. 4, pp. 571-578, April 2001, which are incorporated herein by reference. Speth, et al. provides a case study for a receiver for the DVB standard. Continuous pilot tones transmitted on fixed positions for the OFDM symbols are described to correct carrier frequency offsets that are a multiple integer of a tone. It should be understood that the DVB standard is a broadcast system, wherein base stations transmit or broadcast the same information simultaneously to multiple receivers. As a result, it is not necessary for receivers using the DVB standard to distinguish between different base stations.

Base stations generally broadcast continuously and employ the frequency division duplex system (i.e., separate channels are used for downlink and uplink). A mobile station in such an environment faces the task of synchronizing with a desired base station in the presence of interference from adjacent base stations. Regarding next generation communication systems (e.g., 3.9G or 4G systems), interfrequency handover (handover from one frequency subband to a different frequency subband) may be an important consideration. Obtaining fast and accurate synchronization between a mobile station and a base station is advantageous. The base stations rely on the uniquely identifiable transmitted signals (e.g., the pilot tones) to allow a mobile station to synchronize to a targeted base station in the overage area.

In the synchronization process, the receiver of the mobile station does not know the channel parameters or the delays for the propagation paths as described above as well as carrier frequency offset. The synchronization process can be described as follows. A base station “k” typically has pilot tones on positions given by a fixed set {Setₖ} of pilot tone frequencies and the OFDM communication system typically uses discrete inverse and direct Fourier transforms of size N to produce transmitted signals. When a receiver performs the initial synchronization, the initial offset between the carrier frequency of the transmitting base station and the receiver of the mobile station is assumed to be no more than some limiting frequency difference dFₘₐₓ tones. Thus, the receiver of the mobile station typically searches in a range [−dFₘₐₓ, dFₘₐₓ] around the nominal base station transmitter frequency to lock onto the desired base station.

As a particular example of synchronization, assume that the pilot tones for base station “k,” as suggested by Negi, et al. and Ohno, et al., are equispaced (i.e., {Setₖ}={mₖ+J·m}, m=0, . . . , L−1, where “mₖ” is a positive integer offset specific to base station “k,” “L” is the range of channel multipaths that the OFDM communication system can accommodate, and “J” is an integer constant that provides the pilot tone separation for base station “k,” where N/L≧J). It is assumed that the pilot tones are equally powered. It is further assumed that the mobile station receives the signals from base station “k” (the targeted base station) as well as signals from another base station “j,” which may be an interfering base station. Thus, the mobile station attempts to synchronize to base station “k” and the initial carrier frequency offsets dFⱼ, dFₖ between the mobile station and base stations “j, k,” respectively. Also assume that n=dFⱼ−dFₖ+mⱼ−mₖ lies in the frequency search range [−dFₘₐₓ, dFₘₐₓ]. For this situation, we observe that n+dFₖ+{Setₖ}=dFⱼ+{Setⱼ}, which indicates that the mobile station can lock onto the interfering base station “j” as opposed to targeted base station “k.” Therefore, the mobile station performs additional operations to distinguish that it was locked onto the wrong base station. These operations require additional time, which is a limited resource, especially for an interfrequency handover that has tight switching time requirements.

As an example, consider a base station downlink channel arrangement with frequency components (N=512), 11 pilot tones (L=11) and the separation between pilot tones being 50 (J=N/L). As illustrated in FIG. 2, assume that for base station “k” we have mₖ=0, i.e., {Setₖ}={0, 50, 100, . . . , 500}, while for base station “j”, mⱼ=5, i.e., {Setⱼ}={5, 55, 105, 155, . . . , 505}. Note that this is a particular example of the pilot tone position layout as proposed by Laroia, et al., to solve multicell deployment of an OFDM communication system, in which the initial pilot tone position displacements mₖ and mⱼ are different, the pilot tone separation is a constant J and the pattern frequency-time period is one. Continuing the example, let the searching range for initial synchronization be [−dFₘₐₓ, dFₘₐₓ]=[−10, 10]; and the carrier frequency offsets of the corresponding base stations relative to the receiver's (mobile) carrier frequency are dFₖ=1 and dFⱼ=−2. Note that in the initial synchronization stage, the carrier offsets dFⱼ, dFₖ are not known at the receiver. Due to the carrier offsets, the positions of the pilot tones as observed by the receiver are shifted as dFₖ+{Setₖ}={1, 51, 101, 151, . . . , 501} and dFⱼ+{Setⱼ}={3, 53, 103, 153, . . . , 503}, which again are not known by the receiver. Note that the set dFⱼ+{Setⱼ} is the right circular shift of the set dFₖ+{Setₖ} by n=dFⱼ−dFₖ+mⱼ−mₖ=−2−1+5−0=2, and both sets are in the search range [−10, 10] at the receiver.

Thus, when the receiver performs a search to synchronize to the targeted base station (e.g., base station “k”), it actually detects two base stations at initial offset values of one and three. However, because the pilot tone positions of a base station is a circular shift of the pilot tone positions of the other base station, the receiver has no additional information to determine if the initial offset value of one belongs to base station “k” or to base station “j”. The synchronization is more difficult if the signal from the desired base station “k” is weaker than the signal from the potentially interfering base station “j”. Thus, the receiver will likely synchronize, as Laroia, et al. observed, to the strongest signal base station, which may not be the targeted base station in an interfrequency handover process.

What is needed in the art, therefore, is a system and method of employing a pilot tone pattern design for a plurality of potentially interfering base stations that can reduce the possibility that a receiver of a mobile station can lock onto an interfering base station within its listening range, thereby decreasing the processing necessary to confirm a proper acquisition and synchronization, providing improved communication system performance while, at the same time, reducing the communication start time for an end user.

In addition to the foregoing, current trends in 3.5G, 3.9G and 4G (respectively, generation three-and-a-half, three-point-nine, and four) systems aim at achieving high data rates at relatively low costs, and therefore mandate multicarrier designs, high spectral efficiencies, and Multiple Input, Multiple Output (MIMO) designs. When designing pilot tone patterns for MIMO OFDM systems, one must bear in mind that these systems require a sufficient number of pilot tones to estimate all resolvable paths in the multiple transmit-receive antenna pairs that define the MIMO configuration. The addition of more pilot tones, however, increases the overhead of a signal being transmitted to a receiver.

A need, therefore, exists, for a system and method for placing sufficient pilot tones in a MIMO OFDM system to estimate all resolvable paths in the multiple transmit-receive antenna pairs that define the MIMO configuration, while limiting the amount of overhead added to a signal being transmitted to the receiver.

### BRIEF SUMMARY

Generally described, certain embodiments of the invention provide an improvement over the known prior art by, among other things, providing a method and apparatus of placing pilot symbols in an OFDM system using sets of multidimensional points having a certain structure that is derived from discernible expansions of generalized orthogonal designs. In exemplary embodiments, these sets of multidimensional points are used to form pilot symbols on a two-dimensional frequency-time pilot symbol grid for sampling the flat fading process on various subcarriers of an OFDM MIMO system, transmit antennas, and OFDM symbols. In other words, in exemplary embodiments the multidimensional pilot symbol associated with a particular subcarrier, when viewed as a matrix, is inserted into the transmitted signal by placing the known entries of the matrix across several OFDM symbols and across the various transmit antennas. For example, a certain pilot subcarrier (i.e., a subcarrier, or pilot tone, that is loaded with a symbol known to the receiver, and used for channel estimation) will convey the elements of a 2×2 pilot matrix by transmitting the entries along the first row from a first transmit antenna, the entries along the second row from a second transmit antenna, etc. Further, of the two entries that will be sent from the first antenna, one will be sent during an OFDM symbol and the other during another OFDM symbol, with some periodicity; likewise, for the remaining pilot subcarriers. In this manner, the channel is sampled at the subcarriers used as pilot tones, and by interpolation, the channel values at all subcarriers will be estimated whenever the receiver can estimate the channel values at the pilot tone positions, and provided that the spacing between the subcarriers used as pilot tones is adequate. In addition, the pilot information (i.e., the information that is known to the receiver in the form of known symbols at the pilot tone positions) may be used to perform initial carrier synchronization and OFDM symbol timing while discerning between candidate base stations.

In accordance with one aspect of the invention, a method is provided for placing one or more pilot symbols in a multicarrier multiple-input multiple-output (MIMO) system. In one exemplary embodiment, the method involves first constructing an orthogonal multidimensional constellation including a set of multidimensional constellation points. Next, a pilot symbol may be formed from the orthogonal multidimensional constellation. The pilot symbol may include a set of pilot points that corresponding with the set of multidimensional constellation points.

In one exemplary embodiment, the method further includes expanding the orthogonal multidimensional constellation in order to increase the number of pilot points that can be accommodated (i.e., increase the number of pilot points in the set of pilot points making up the pilot symbol). The structure of the orthogonal multidimensional constellation, before and after expansion, may, in one exemplary embodiment, be invariant to flat fading.

In another exemplary embodiment, the pilot symbol may include a matrix having one or more rows and one or more columns, wherein each row of the matrix corresponds with a separate, or different, antenna. The method of this exemplary embodiment may further include transmitting the pilot points associated with a row of the matrix from the corresponding antenna. This may, in another exemplary embodiment, include transmitting respective pilot points during a separate orthogonal frequency division multiplexing (OFDM) symbol. In yet another exemplary embodiment, upon receipt, the pilot points may be capable of being used to perform an initial carrier synchronization and OFDM symbol timing while discerning between one or more candidate base stations.

According to another aspect of the invention, an apparatus is provided for placing one or more pilot symbols in a multicarrier multiple-input multiple-output (MIMO) system. In one exemplary embodiment, the apparatus includes a pilot tone generator configured to generate and interleave one or more pilot tones for carrying a respective one or more pilot symbols. Each pilot symbol may be formed from an expanded orthogonal multidimensional constellation and may include a set of pilot points that correspond with a set of multidimensional constellation points of the expanded orthogonal multidimensional constellation.

According to yet another aspect of the invention, a mobile station is provided. In one exemplary embodiment, the mobile station includes a receiver that is configured to receive a pilot symbol that is formed from an orthogonal multidimensional constellation. The pilot symbol may include a set of pilot points that correspond with a set of multidimensional constellation points of the orthogonal multidimensional constellation. In one exemplary embodiment, the receiver includes one or more antennas. In this exemplary embodiment, receiving a pilot symbol involves receiving the set of pilot points via the one or more antennas and during one or more orthogonal frequency division multiplexing (OFDM) symbols.

According to one aspect of the invention, a system is provided for transmitting one or more pilot symbols. In one exemplary embodiment, the system includes a base station and a mobile station, wherein the base station is configured to generate and transmit, and the mobile station configured to receive, one or more pilot symbols formed from an orthogonal multidimensional constellation.

In one exemplary embodiment the base station is further configured to construct the orthogonal multidimensional constellation and to form the pilot symbol from the orthogonal multidimensional constellation formed. In another exemplary embodiment, the base station is further configured to expand the orthogonal multidimensional constellation, such that the pilot symbol includes additionally pilot points. In yet another exemplary embodiment, transmitting the pilot symbol comprises transmitting the set of pilot points over one or more antennas and in one or more orthogonal frequency division multiplexing (OFDM) symbols. The mobile station of this exemplary embodiment may further be configured to use the pilot symbols received to perform initial carrier synchronization and OFDM symbol timing.

According to yet another aspect of the invention, a computer program product is provided for placing one or more pilot symbols in a multicarrier multiple-input multiple-output (MIMO) system, wherein the computer program product includes at least one computer-readable storage medium having computer-readable program code portions stored therein. In one exemplary embodiment, the computer-readable program code portions include a first executable portion for constructing an orthogonal multidimensional constellation including a set of multidimensional constellation points, and a second executable portion for forming a pilot symbol from the orthogonal multidimensional constellation. The pilot symbol may include a set of pilot points corresponding with the set of constellation points of the orthogonal multidimensional constellation.

According to another aspect of the invention, an integrated circuit assembly is provided for placing pilot symbols in a multicarrier multiple-input multiple-output (MIMO) system. In one exemplary embodiment, the integrated circuit assembly includes a first logic element for constructing an orthogonal multidimensional constellation including a set of multidimensional constellation points, and a second logic element for forming a pilot symbol from the orthogonal multidimensional constellation.

### BRIEF DESCRIPTION OF THE DRAWINGS

Having thus described the invention in general terms, reference will now be made to the accompanying drawings, which are not necessarily drawn to scale, and wherein:

FIG. 1 illustrates a block diagram of a pattern of positions of pilot tones shared by a plurality of base stations;

FIG. 2 illustrates a block diagram of a pattern of positions of pilot tones for a plurality of base stations;

FIG. 3 illustrates a system level diagram of an embodiment of an OFDM communication system in accordance with the principles of embodiments of the invention;

FIG. 4 illustrates a block diagram of an embodiment of a transmitter employable in a mobile station constructed according to the principles of embodiments of the invention;

FIG. 5 illustrates a block diagram of an embodiment of a receiver employable in a mobile station constructed according to the principles of embodiments of the invention;

FIG. 6 is a schematic block diagram of an entity capable of operating as a mobile station and/or base station in accordance with exemplary embodiments of the invention; and

FIG. 7 is a schematic block diagram of a mobile station capable of operating in accordance with an exemplary embodiment of the invention.

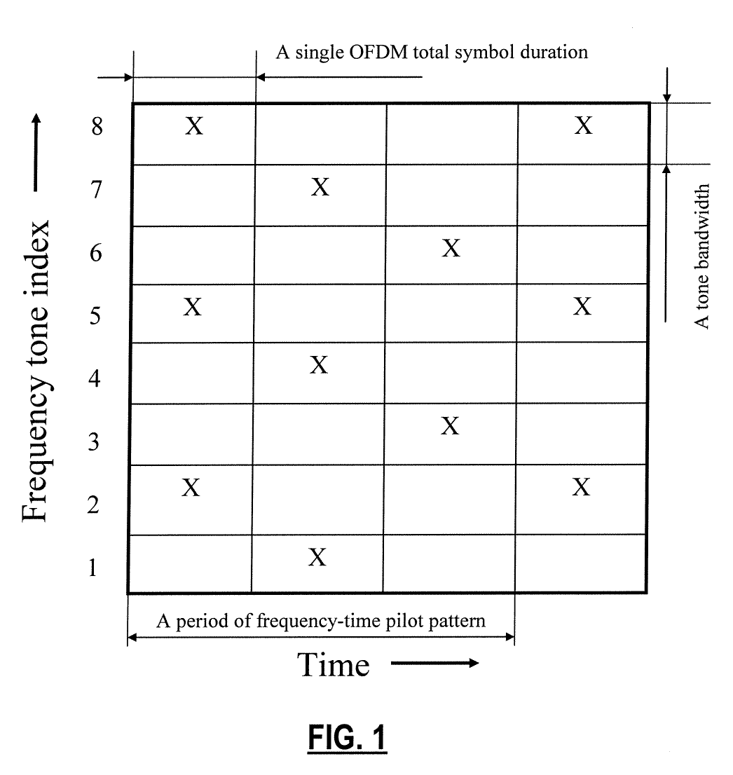

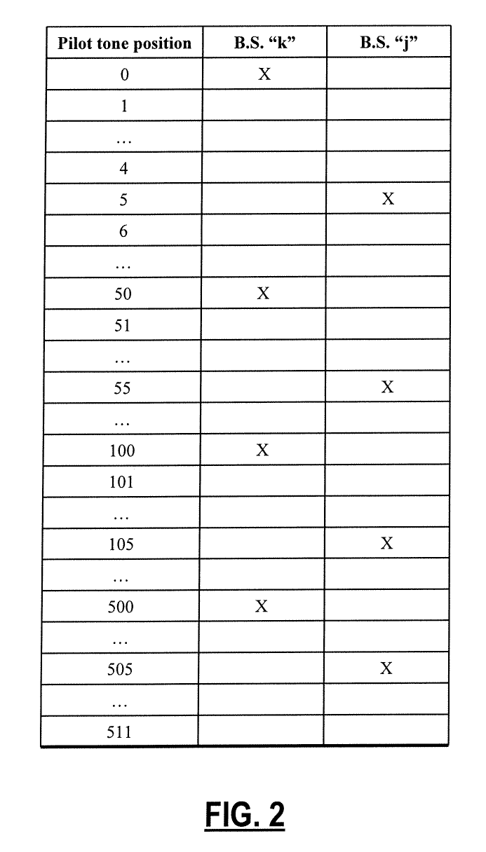

### DESCRIPTION

Embodiments of the invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview

As stated above, the placement of pilot symbols in an OFDM MIMO system increases the overhead of signals being transmitted to a receiver. In order to reduce this overhead, pilot symbols can be placed in both frequency and time domains (i.e., pilots are placed on spaced subcarriers (frequency domain), as well as in spaced OFDM symbol intervals (time domain)). (See Hoeher, P; Kaiser, S; Roberson, P, “Two-dimensional pilot-symbol-aided channel estimation by Wiener filtering,” Proc. 1997 IEEE International Conference on Acoustics, Speech, and Signal Processing, vol. 3, pp. 1845-1848, 21-24 Apr. 1997, the contents of which are incorporated herein by reference in their entirety). The pilot symbols can then be viewed as multidimensional symbols whose components are placed both in the time and in the frequency domains.

The placement of the pilot symbols follows a grid that ‘samples,’ in two-dimensions, certain subcarriers and certain OFDM symbols. The spacing, therefore, in frequency and time, of the pilot symbols should be sufficient, from the perspective of the two-dimensional sampling theorem, to capture the variations across subcarriers due to frequency selectivity, and in time due to the time varying nature. The extent of variation in frequency and time are given by the coherence bandwidth and correlation time, respectively. If the two-dimensional sampling rates are satisfied, then the estimation of pilots suffices to estimate the channel at all subcarriers, for all OFDM symbols within a coherence time interval.

In essence, the variation of the frequency selective channel manifests in such a way that the flat fading channel values at the sampled subcarriers remain approximately constant during the OFDM symbols that lie within a coherence time interval and are to be sampled by the pilot symbols. Therefore, if a multidimensional pilot symbol is used on a frequency-time grid, the pilot components can be associated with a certain subcarrier (a flat fading process to be estimated), various transmit antennas, and different OFDM symbol intervals where the respective fading coefficient remains approximately constant.

From the perspective of any receive antenna, the multidimensional pilot symbols can be viewed as matrices, of possibly complex values, whereby the rows are associated with transmit antennas and the columns with multiple-input multiple-output (MIMO) channel uses (i.e., uses of a MIMO channel, whereby one use of a MIMO channel having N-transmit antennas comprises sending N-symbols from N-transmit antennas), wherein the channel is flat fading and remains constant during the various channel uses. The multidimensional pilot symbol will, therefore, experience Rayleigh block fading.

The challenge is to provide enough such multidimensional pilot “points” and to ensure that during estimation of the channel at the grid points, the different pilot points are as discernible as possible, where discernability is defined in terms of preserving the relative Euclidean distance between valid constellation points so that when the pilots are placed on different subcarriers, they are least likely to be mistaken for one another and the MIMO channel estimation is likely to succeed.

In general, therefore, the set of valid multidimensional points that are to supply the pilot symbols should be robust with respect to block fading (i.e., the relative Euclidean distance between various candidate pilot points should not be altered by multiplicative distortion due to fading) in order to facilitate correct separation of pilot symbols during channel estimation (i.e., to ensure that the pilot symbols are discernible). In addition, the pilot symbols will preferably have a constant norm (i.e., the pilot symbols will be on a hypersphere) in order to better separate the pilot symbols in terms of Euclidean distance. The squared norm of a vector is the sum of the squared magnitudes of the vector elements. If several multidimensional vectors are on a hypersphere, then all of the norms will be equal (i.e., the radius of the hypersphere), and those vectors have a constant norm. The norm is the length of the vector in multidimensional space (e.g., in three dimensions the norm is the usual length of a vector). Finally, the pilot symbols should facilitate, whenever possible, the initial carrier synchronization and OFDM symbol timing, for example, when changing a base station for the purpose of receiving higher bandwidth service.

In order to fulfill at least these objectives, exemplary embodiments of the invention propose to use points from a multidimensional constellation that is rich enough, is resilient to block fading, and resides on a hypersphere, for the placement of pilot symbols on a frequency-time grid.

In particular, exemplary embodiments provide a means of placing multidimensional pilot points in a multicarrier MIMO system by constructing pilot symbols from multidimensional constellations having a structure that is derived from discernible expansion of generalized orthogonal designs. This enables the multidimensional constellations to have symmetries that can be preserved despite multiplicative distortions inherent to a fading channel (i.e., constellations whose shape is preserved in flat, block fading channels). These pilot symbols can then be used for sampling the flat fading processes on various subcarriers of an OFDM MIMO system, transmit antennas, and OFDM symbols.

In addition, another aspect of the invention is to use the sampled pilot information to perform initial carrier synchronization and OFDM symbol timing while discerning between candidate base stations.

Embodiments of the invention are beneficial because they facilitate the initial carrier synchronization and OFDM symbol timing acquisition of a desired base station. In addition, it improves the quality of channel estimation in an OFDM MIMO system of any flavor (e.g., Frequency Division Multiple Access (FDMA), Time Division Multiple Access (TDMA), Code Division Multiple Access (CDMA), or Spread Spectrum Multicarrier Multiple Access (SS-MC-MA)).

OFDM System

The making and using of exemplary embodiments are discussed in detail below. It should be appreciated, however, that embodiments of the invention provide many applicable inventive concepts that can be embodied in a wide variety of specific contexts. The specific embodiments discussed are merely illustrative of specific ways to make and use the invention, and do not limit the scope of the invention.

The principles of the invention will be described with respect to exemplary embodiments in a specific context, namely, an OFDM communication system having a plurality of base stations employing different patterns of positions of pilot tones communicating over a channel to receivers of respective mobile stations. The mobile stations are communicating with a targeted base station to share training data for reliable data reception without substantial interference from another base station. It should be understood that the channel may be a dedicated channel for synchronization information and the like, or it may be a portion of a channel that carries user information. The broad scope of the invention is not limited to the classification of the channel.

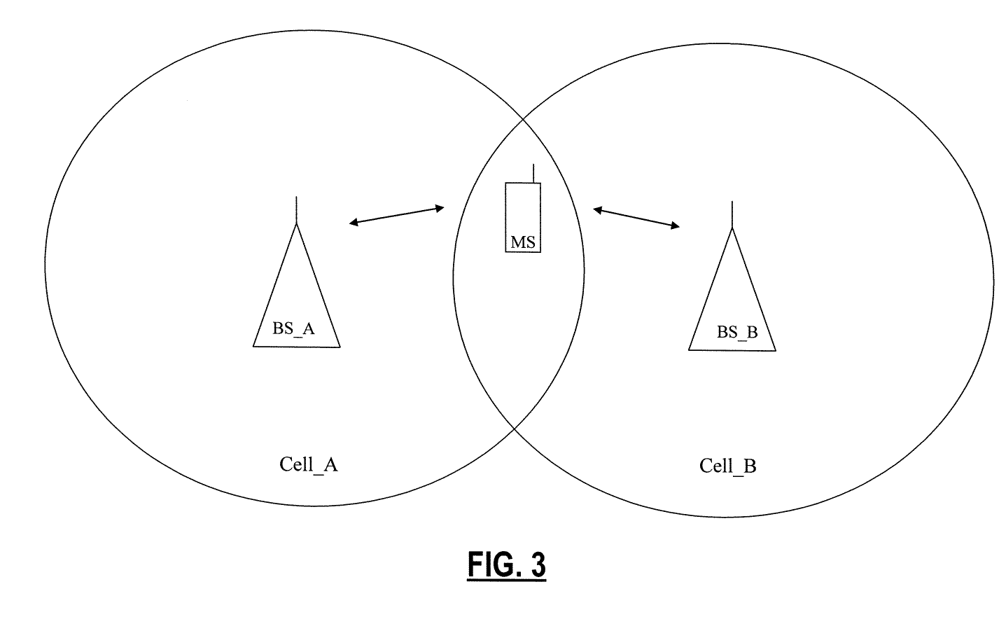

Referring now to FIG. 3, illustrated is a system level diagram of an embodiment of an OFDM communication system in accordance with the principles of the invention. In the illustrated embodiment, the OFDM communication system is a cellular communication system that includes first and second base stations BS_A, BS_B and a mobile station MS. As illustrated, each base station BS_A, BS_B covers a cell designated as Cell_A for the first base station BS_A and Cell_B for the second base station BS_B. In the multicell environment of the cellular communications system, the mobile station MS may receive multiple signals over a channel from neighboring cells.

In the environment of a cellular communication system with a multicell OFDM communication system, “frequency reuse” refers to the allocation of different frequency subbands in adjacent cells to substantially avoid intercellular interference. For example, a cell surrounded by six adjacent cells may employ the allocation of seven frequency subbands to avoid mutual interference. Frequency reuse “one” means that adjacent base stations operate in the same frequency subband, and do not employ different frequency subbands for non-interfering operation. Assuming that frequency division duplex is used for transmission and reception (i.e., downlinks and uplinks employ different frequency subbands), the base stations typically continuously transmit in a particular, allocated common subband. A transmitter of the base station accommodates a system and method for positioning the frequencies of the pilot tones to, for instance, facilitate the carrier offset estimation for an initial signal acquisition process between a base station and a mobile station. As a result, the mobile stations can more readily synchronize with the targeted base station without a degradation in communication performance due to interference from another base station.

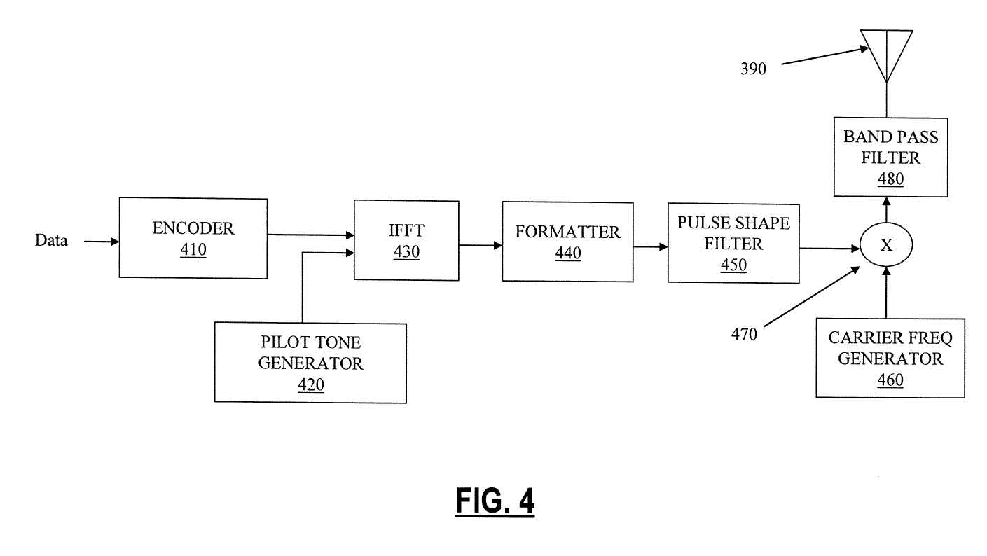

Turning now to FIG. 4, illustrated is a block diagram of an embodiment of a transmitter employable in a base station constructed according to the principles of the invention. A stream of bits from a data source is encoded (e.g., mapped into points of a “constellation” in a complex plane) via an encoder 410 of the base station. The encoder 410 may include serial-to-parallel conversion of the data. A pilot tone generator 420 generates and interleaves pilot tones into a pattern of positions of pilot tones that is a perturbation of equispaced tones for use by a receiver such as a mobile station in an OFDM communication system.

In essence, as discussed above, pilot tones are subcarriers, and the value modulated on any such subcarrier is a pilot symbol. A subset of the subcarriers, usually equally spaced, is allocated to carry pilot symbols. Each subcarrier would thereby sample the channel in the frequency domain, since it carries symbols known to the receiver. Naturally, this channel sampling must capture the multiple antennas and the variation with time of the channel frequency response on each subcarrier. Further, the complex (pilot) symbols that come from one multidimensional pilot symbol and are meant to probe one particular pilot tone (or subcarrier) are allocated to the various transmit antennas (e.g., row wise) and to successive OFDM symbols, according to some periodicity. Thereby, for each transmit antenna, a grid in frequency (subcarriers) and time (OFDM symbols) is created for sampling the channel. Once the receiver estimates, on each antenna, the channel values at the pilot positions (based on the known pilot symbols) it interpolates in order to characterize the channel at all subcarriers (not only those allocated as pilot tones).

Returning to FIG. 4, the encoded data and the pilot tones are thereafter converted into a sampled, time-domain sequence via an IFFT module 430. A cyclic prefix is added via a formatter 440 to assist in substantially avoiding intersymbol interference, followed by a pulse shape filter 450.

The resulting waveform modulates a carrier frequency waveform produced by carrier frequency generator 460 via a multiplier 470 and the resulting product waveform is filtered by a band pass filter 480. The filtered signal may be amplified by an amplifier (not shown) and is coupled to an antenna 490 to produce a transmitted signal. It should be understood that while the pilot tone generator 420 is shown located upstream of the IFFT module 430, the pilot tone generator 420 may be located at other positions in the transmitter to accommodate a particular application. While the transmitter includes a single path to encode, modulate and transmit the signal, it should be understood that multiple paths may be employed to accommodate multiple users. Also, multiple transmit antennas may be employed, each having their own pilot tone generator. For simplicity of description, a single transmit antenna is depicted.

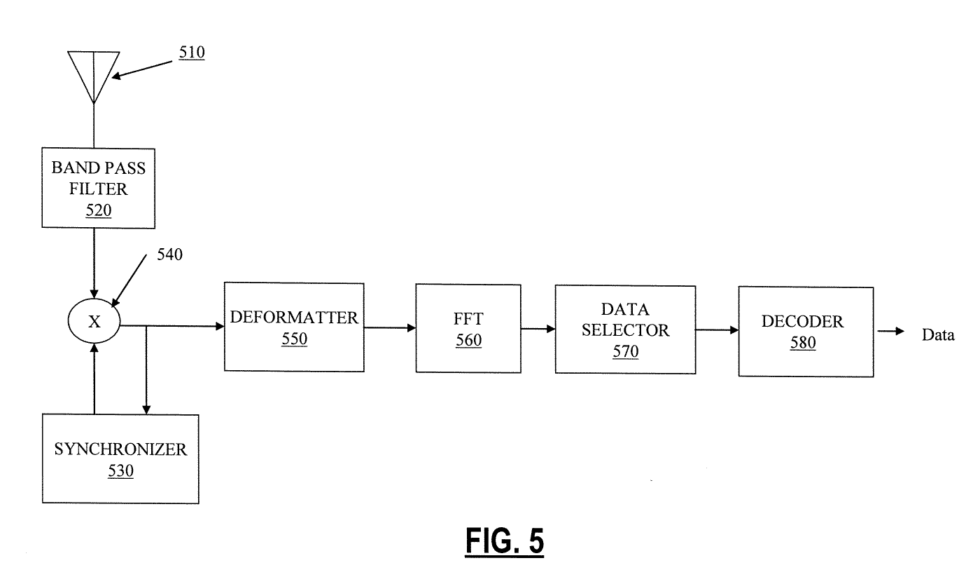

Turning now to FIG. 5, illustrated is a block diagram of an embodiment of a receiver employable in a mobile station constructed according to the principles of embodiments of the invention. At the receiver, a transmitted signal is received (also now referred to as a received signal) via an antenna 510 and is filtered by a band pass filter 520. A detection process includes carrier frequency generation, timing and synchronization via a synchronizer 530, which produces a local carrier signal synchronized with the carrier signal generated at the transmitter. The synchronizer 530 may include a phase-locked loop or other technique for signal timing and synchronization as is well understood in the art. The local carrier signal and the band-pass filtered received signal are multiplied by a multiplier 540. The cyclic prefix is removed in a deformatting process via a deformatter 550 from the detected signal. The result is a sampled, time-domain sequence corresponding to the time-domain sequence as described with respect to FIG. 4.

A fast Fourier transform (FFT) is thereafter performed on the time-domain sequence via a FFT module 560, producing a sequence of points in the complex plane corresponding to the original transmitted data. The pilot tones are then removed from this sequence by a data selector 570 and the remaining points are remapped into the original transmitted data sequence (e.g., remap complex points into binary data) by a decoder 580, which may include parallel-to-serial data conversion as well. The data is thereafter provided for the benefit of a user.

Analogous to the transmitter illustrated and described with respect to FIG. 4, the receiver is provided for illustrative purposes and may be implemented in general purpose computers or in special purpose integrated circuits. Additionally, the subsystems of the transmitter and receiver of FIGS. 4 and 5 have been described at a high level, and for a better understanding of OFDM communication systems. For more details regarding OFDM communication systems and the related subsystems see, for example, “Digital Communications,” by John G. Proakis, published by McGraw-Hill Companies, 4th Edition (2001).

As mentioned above, to allow a receiver such as a receiver for a mobile station using orthogonal frequency division multiplexing, to reliably receive and detect the information in a signal frame (even with the insertion of a cyclic prefix), it is preferable to know the parameters of the channel such as the carrier frequency offset, channel gain and phase, and overall timing, all of which are generally unknown and varying at the receiver for reasons described above. To compensate for unknown channel parameters, the transmitter of the base station inserts a set of pilot tones that are transmitted to the receivers of the mobile stations. In essence, the pilot tones provide “training data” for the receiver.

Exemplary Base Station and/or Mobile Station

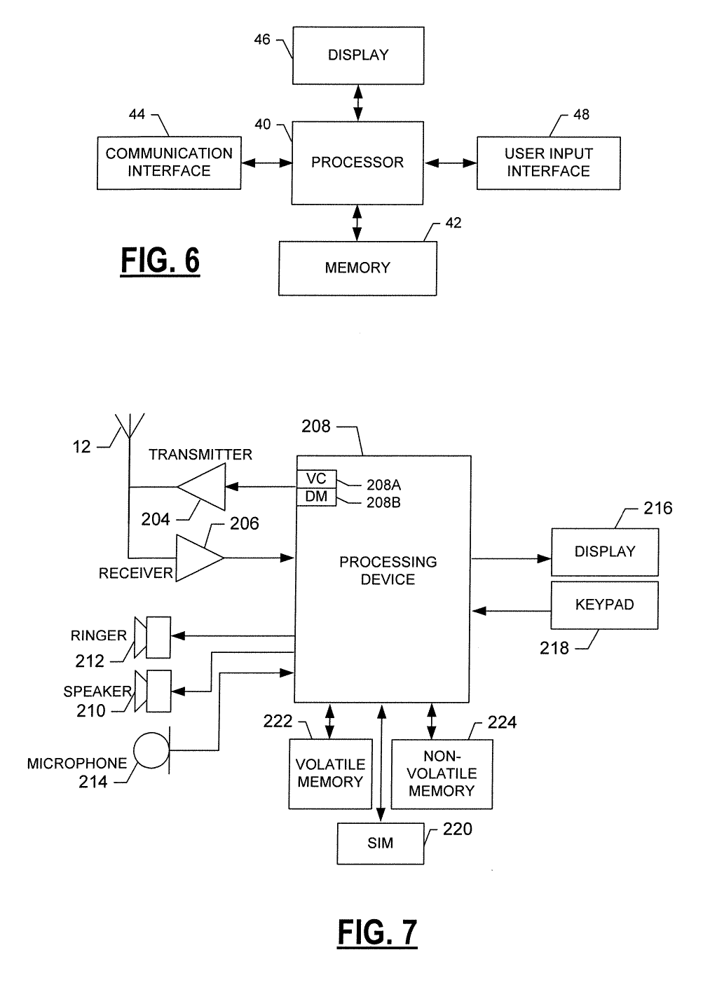

FIG. 6 is a schematic block diagram of an entity capable of operating as a mobile station and/or a base station in accordance with exemplary embodiments of the invention. The entity capable of operating as a mobile station and/or base station includes various means for performing one or more functions in accordance with exemplary embodiments of the invention, including those more particularly shown and described herein. It should be understood, however, that one or more of the entities may include alternative means for performing one or more like functions, without departing from the spirit and scope of the invention. For example, one or more of the entities may include an integrated circuit assembly including one or more logic elements or integrated circuits integral or otherwise in communication with the entity or more particularly, for example, a processor 40 of the entity. As shown, the entity capable of operating as a mobile station and/or base station can generally include means, such as a processor 40 connected to a memory 42, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the invention.

In addition to the memory 42, the processor 40 can also be connected to at least one interface or other means for displaying, transmitting and/or receiving data, content or the like. In this regard, the interface(s) can include at least one communication interface 44 or other means for transmitting and/or receiving data, content or the like, as well as at least one user interface that can include a display 46 and/or a user input interface 48. The user input interface, in turn, can comprise any of a number of devices allowing the entity to receive data from a user, such as a keypad, a touch display, a joystick or other input device.

Reference is now made to FIG. 7, which illustrates one type of mobile station that would benefit from embodiments of the invention. It should be understood, however, that the mobile station illustrated and hereinafter described is merely illustrative of one type of mobile station that would benefit from the invention and, therefore, should not be taken to limit the scope of the invention. While several embodiments of the mobile station are illustrated and will be hereinafter described for purposes of example, other types of mobile stations, such as personal digital assistants (PDAs), pagers, laptop computers and other types of electronic systems, can readily employ embodiments of the invention.

The mobile station includes various means for performing one or more functions in accordance with exemplary embodiments of the invention, including those more particularly shown and described herein. It should be understood, however, that the mobile station may include alternative means for performing one or more like functions, without departing from the spirit and scope of the invention. More particularly, for example, as shown in FIG. 7, the mobile station includes an antenna 12, a transmitter 204, a receiver 206, and means, such as a processing device 208, e.g., a processor, controller or the like, that provides signals to and receives signals from the transmitter 204 and receiver 206, respectively. As a further example, the mobile station may include an integrated circuit assembly including one or more logic elements or integrated circuits integral or otherwise in communication with the mobile station or more particularly, for example, the processing device 208 of the mobile station. The signals provided to and received from the transmitter 204 and receiver 206 may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 208, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality to convolutionally encode and interleave message and data prior to modulation and transmission. The processing device can additionally include an internal voice coder (VC) 208A, and may include an internal data modem (DM) 208B. Further, the processing device 208 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 210, a ringer 212, a microphone 214, a display 216, all of which are coupled to the controller 208. The user input interface, which allows the mobile device to receive data, can comprise any of a number of devices allowing the mobile device to receive data, such as a keypad 218, a touch display (not shown), a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the invention, the memory may store computer program code for enabling the mobile station to receive transmitted signals including pilot symbols placed in accordance with exemplary embodiments of the invention.

It should be understood that while the mobile station was illustrated and described as comprising a mobile telephone, mobile telephones are merely illustrative of one type of mobile station that would benefit from the invention and, therefore, should not be taken to limit the scope of the invention. While several embodiments of the mobile station are illustrated and described for purposes of example, other types of mobile stations, such as personal digital assistants (PDAs), pagers, laptop computers, tablets, and other types of electronic systems including both mobile, wireless devices and fixed, wireline devices, can readily employ embodiments of the invention.

Use of Expanded Orthogonal Multidimensional Constellations for Pilot Symbol Placement

As stated above, the placement of pilot symbols increases the overhead of signals being transmitted. This overhead can be reduced to some extent by placing the pilot symbols in the frequency and time domains. The pilot symbols can, therefore, be viewed as multidimensional pilot symbols each having sets of multidimensional pilot points. Exemplary embodiments of the invention propose placing these multidimensional pilot points in a multicarrier MIMO system by constructing the pilot symbols from multidimensional constellations having a structure that is derived from discernible expansion of generalized orthogonal designs. This, among other things, enables the multidimensional constellations to have symmetries that can be preserved despite multiplicative distortions inherent to a fading channel (i.e., constellations whose shape is preserved in flat, block fading channels).

It has been proven that the shape of orthogonal multidimensional constellations is resilient to flat fading channels. (See H. Schulze, “Geometrical Properties of Orthogonal Space-Time Codes,” IEEE Commun. Letters, vol. 7, pp. 64-66, January 2003; also, M. Gharavi-Alkhansari and A. B. Gershman, “Constellation Space Invariance of Orthogonal Space-Time Block Codes,” IEEE Trans. Inform. Theory, vol. 51, pp. 331-334, January 2005). This is mainly due to the fact that such designs allow any constellation point to be expressed as a linear combination of basis matrices. Using orthogonal multidimensional constellations for the placement of pilot symbols in the frequency-time grid, therefore, provides for pilot symbol discernability. In other words, where multidimensional pilot points are placed at specific Euclidean distances from one another, these distances will not change as the multidimensional constellation is transmitted over a non-ideal communications channel. The points, therefore, will remain at a sufficient distance from one another to be discernible.

It has also been shown that these orthogonal constellations can be expanded (i.e., the number of constellation points defining the constellation can be increased) without losing their shape invariance property. (See U.S. application Ser. No. 11/112,270 entitled Method and Apparatus for Constructing MIMO Constellations that Preserve Their Geometric Shape in Fading Channels, and D. M. Ionescu and Z. Yan, “Fading Resilient Super-Orthogonal Space-Time Signal Sets: Can Good Constellations Survive in Fading,” submitted to IEEE Trans. Inform. Theory; available at http://arxiv.org/abs/cs.IT/0505049, (hereinafter “Ionescu et al.”) the contents of each of which are incorporated herein by reference in their entirety). By increasing the number of constellation points, an increased number of pilot points to cover multiple antennas, as well as the relevant coherent bandwidth, can be attained.

Thus, according to exemplary embodiments of the invention, by constructing pilot symbols from expanded orthogonal multidimensional constellations, a sufficient number of pilot symbols can be added to estimate all resolvable paths in the multiple transmit-receive antenna pairs that define the MIMO configuration, and, because the shape of the expanded constellation is invariant to flat-fading, the pilot symbols will be discernible throughout channel estimation.

In addition, such constellations obtained from generalized orthogonal designs have a multidimensional lattice structure and lie on a hypersphere. For example, if there are two transmit antennas, an eight-dimensional expanded constellation of 32 points is the second shell of a D₄⊕D₄ lattice (the direct sum of two four-dimensional checkerboard lattices). As stated above, it is preferable that the pilot symbols have a constant norm, which is guaranteed where the symbols lie on a hypersphere. This helps to ensure good relative spacing between valid pilot symbols (i.e., multidimensional points).

Initial Carrier Synchronization and OFDM Symbol Timing

By basic properties of the Fourier transform, a (radian) frequency carrier offset Δω translates (after Fourier transformation) in a frequency domain shift of all subcarrier frequencies by Δω. As carrier offset correction values (from within a search range) are applied in the time domain, the frequencies of all subcarriers that host pilots are shifted by the same amount. At some point the discrete set of points that form the expected support set of the pilot symbols will correctly match the placement of pilots in the signal received from the intended base station (BS) (to which a mobile station is listening to in an attempt to acquire and lock). That event (corresponding to a carrier offset Δω) needs to be detected and distinguished (discussed below) from all candidate BSs. Note that the presence of a symbol timing offset Δt₀ translates into a multiplication in the frequency domain by exp(jωΔt₀); because at this stage all processing will be non-coherent—i.e., only magnitudes are relevant—this does not affect the carrier synchronization algorithm (as |exp(jωΔt₀)|=1, see below).

The following potential problem is particularly possible in a scenario with equally spaced pilots, even if a relative cyclic shift between pilot support points at neighboring BSs is enforced (see e.g. Laroia et al.). It is possible for the discrete set of points that form the support set for the equally spaced pilot symbols at several candidate BSs to correctly match, up to a cyclic shift, the placement of pilots in the signal received from the intended BS. If that happens, then two or more carrier offset correction values will cause the pilot support grids of those BSs to match the placement of pilots in the signal from the intended BS (to which the mobile station is trying to synchronize). In that case, a mechanism is needed to aide the mobile station in locking on to the intended BS, and to help identify and exclude the BSs that have cyclically shifted (but equally spaced) pilots. If such a mechanism is absent, then the alternative is to actually decode the respective frames (from all BSs), then identify the respective BS IDs, etc. However, this adds time, delay, and inefficiency.

One solution around this problem is pursued in related U.S. Provisional Application No. 60/685,034, entitled System and Method for Selecting Pilot Tone Positions in Communication System, filed May 26, 2005, the contents of which are incorporated herein by reference in their entirety. According to one solution provided in this application, the pilot support grids from neighboring BSs are simply, and intentionally, skewed, in addition to being cyclically shifted relative to one another, thus preventing any cyclic shift of a desired pilot placement from matching the pilot placement of an undesired BS. One drawback to this solution lies in the fact that unequally spaced pilots (a consequence of this approach) are suboptimal (See H. Minn and N. Al-Dhahir, “Optimal Training Signals for MIMO OFDM Channel Estimation,” Globecom 2004, pp. 219-224). However, the loss might be contained.

Exemplary embodiments of the invention propose a qualitatively different solution to the initial carrier synchronization and OFDM symbol timing acquisition. As stated above, pilot symbols are multidimensional points. In other words, if there are N transmit antennas, a pilot symbol meant to probe (i.e., sample) the frequency selective MIMO channel in the frequency domain, at subcarrier i₀, can be a 2×2 complex matrix, whose columns and rows are associated with transmit antennas and time epochs, respectively. Herein, a time epoch corresponds to one OFDM symbol epoch. In general, as discussed above, the pilot symbols are from a discernible constellation expansion of a generalized orthogonal design. A multidimensional point associated with a pilot symbol is a K×T matrix (See Ionescu et al.). Subscript i refers to the ith (multidimensional) pilot symbol. In addition, the usual isometry that maps s=[z₁ . . . z_{K}]^{T} εC^{K} to the real vector χ=[ [symbol] (z₁), [symbol] (z₁) . . . , [symbol] (z_{K}), [symbol] (z_{K})]^{T} is used. It has been shown that the vector of observations during all channel uses pertaining to the i th pilot symbol can be arranged into a real vector (by the above isomorphism) to re-write the receive equation as yᵢ=∥hᵢ∥Gχᵢ+nᵢ, where G is an orthogonal matrix, n represents a noise and interference term, which will be omitted for simplicity (the pilot symbols have a higher Signal-to-Noise Ratio (SNR)). (See Ionescu et al., Sec. II.C) In addition, hᵢ is the N×1 channel vector of flat fading coefficients from the transmit antennas to an arbitrary receive antenna. Further, hᵢ is constant over the time epochs covered by a pilot symbol.

The processing during initial acquisition and synchronization is of course non-coherent. First, the receiver must compute ∥yᵢ∥ for each carrier offset correction value (when this compensates for the carrier offset the expected pilot positions will all match the pilot placement in the signal transmitted by the intended BS), wherein ∥yᵢ∥=(yᵢ^{T}yᵢ)^{1/2}=∥h_{i∥∥χ}ᵢ∥. Preferably, the pilot symbols are on a hypersphere, which will insure that ∥χᵢ∥=κ, ∀i and ∥yᵢ∥−(yᵢ^{T}yᵢ)^{1/2}=κ∥hᵢ∥.

Collecting the energy in all observations at the known pilot positions, leads (for the correct carrier offset correction value) to diversity combining the channel energies in all vectors hᵢ. The resulting value obeys a chi-squared distribution, and leads to a peak energy which signals that the compensated carrier offset corresponds to a BS that has the same pilot placement up to a cyclic shift. If only one global maximum is found while applying carrier offset correction values from an expected range, then the correct BS has been identified and synchronized with. The last stage will be OFDM symbol timing acquisition.

However, it is possible for the discrete set of points that form the support set for the equally spaced pilot symbols at several candidate BSs to correctly match, up to a cyclic shift, the placement of pilots in the signal received from the intended BS, see above. In that case a clear global maximum will not be found, but rather several close maxima will be observed.

Due to the structure present in the pilot symbols, this ambiguity can be resolved in a second stage, wherein the algorithm must compute, for all valid \tilde{χ}ᵢ, \tilde{χ}G^{T}yᵢ=∥hᵢ∥\tilde{χ}ᵢ^{T}G^{T}Gχᵢ=∥hᵢ∥\tilde{χ}ᵢ^{T}χᵢ≦∥hᵢ∥∥χᵢ∥²=κ∥hᵢ∥, where the inequality follows via Cauchy-Schwartz, and equality is achieved if and only if \tilde{χ}ᵢ=χᵢ. Summing up over all known pilot symbol positions will allow the receiver to differentiate among the BSs that have identical pilot symbol placement up to a cyclic shift in the frequency domain, thereby resolving the ambiguity.

Note that the above argument is a simplified version of a more complete proof. In reality, the matrix G, as represented above and in Ionescu et al., lumps together the effect of the channel and certain basis matrices associated with the elements of each χᵢ vector. It is possible to separate the contributions of the channel and the basis matrices, respectively, by expressing G as a product between a matrix that depends only on the channel and one that depends only on the basis matrices (known to the receiver). The essential part, however, is the fact that the Cauchy-Schwartz inequality can be invoked as above, after computing a straightforward norm, which is typical of noncoherent processing.

Note that the vectors χᵢ that lead to the (multidimensional) pilot symbols (e.g., represented in matrix form) can be orthogonal sequences, such as Hadamard (including complex version), which will insure orthogonality. It is also possible to arrange the nonzero observations in yᵢ to correspond to the tested χᵢ (See Ionescu et al.).

This is the essence of the method for resolving the ambiguity between BSs that have identical pilot symbol placement up to a cyclic shift in the frequency domain (see e.g., Laroia et al.).

It is possible to allow, in a very limited number of cases, the option of decoding the messages of all BSs that are not clearly resolved after the second stage. This will rarely be needed, since there is a very low probability of false alarm.

Finally, it is conjectured that the higher the dimensionality of the pilot symbols the lower the scalar product \tilde{χ}ᵢ^{T}χᵢ, which, if true, would help better resolve BS ambiguities, since points can be more efficiently spaced apart on a hypersphere if the dimensionality of the embedding space is higher.

The physical interpretation of the above conjecture is that it is less efficient to rely on pilot symbols having diagonal matrix form

$$[ \begin{matrix}{p}_{0}^{( 1 )} & 0 \\ 0 & {p}_{1}^{( 2 )}\end{matrix} ]$$

(N=2 transmit antennas assumed). Clearly, a pilot of this form has smaller dimensionality than one with all nonzero entries.

As proof, consider two points A=(a₁, . . . , aₙ), B=(b₁, . . . , bₙ), on a hypersphere in n dimensions. Together with the center of the sphere, O, the two points form a two-dimensional triangle in an n-dimensional space. The two points can be viewed as vectors a=[a₁, . . . , aₙ]^{T} b=[b₁, . . . , bₙ]^{T}. The Cauchy-Schwartz inequality implies

$${a}^{T} b = {\sum }_{i} {a}_{i} {b}_{i} \leq ‖ a ‖ ‖ b ‖ .$$

Note that the left hand side vanishes when a⊥b, in which case the scalar product vanishes. Thereby, decreasing

$${a}^{T} b = {\sum }_{i} {a}_{i} {b}_{i} ,$$

when orthogonality does not hold, requires necessarily lowering the attainable upper bound (maximum) ∥a∥∥b∥. But the length of the side A̅B̅, i.e., the Euclidean distance d_{E}(a,b), verifies d_{E}²(a,b)=∥a∥²+∥b∥²−2 cos θ∥a∥∥b∥, where θ is the angle ≮AOB. Then, taking into account the fact that ∥a∥=∥b∥=κ (points on the hypersphere), it follows that

∥a∥∥b∥=(∥a∥²+∥b∥²−d_{E}²(a,b))/2 cos θ≧(2κ²−d_{E}²(a,b))/2, unless a⊥b. Thereby lowering ∥a∥∥b∥ in the absence of orthogonality requires increasing the Euclidean distance d_{E}(a,b). It is well known that a given number of points can be placed farther apart from one another on the surface of a hypersphere when the dimensionality of the hypersphere is higher.

This completes the proof of the fact that in order to lower \tilde{χ}ᵢ^{T}χᵢ the dimensionality of the pilot symbols should be as high as possible, which in turn means that pilots of diagonal matrix form are less efficient. The conjecture can now be stated as a Lemma.

Another question is whether the pilot symbols can be arbitrary unitary matrices, rather than having the structure discussed above (i.e., being from a discernible constellation expansion of a generalized orthogonal design). In other words, can the complex values (corresponding to respective antennas and OFDM symbol epochs) that form a multidimensional pilot symbol for estimating channel coefficient at subcarrier i₀ (all transmit antennas) form simply a unitary matrix?

As shown below, unitary is not sufficient. Indeed, assume that the multidimensional pilot symbols are nothing more than unitary matrices Pᵢ. Then yᵢ=Pᵢhᵢ and the only non-coherent processing is finding ∥yᵢ∥—e.g., by searching over \tilde{P}ᵢyᵢ=\tilde{P}ᵢPᵢhᵢ, or directly computing ∥yᵢ∥ as the sum of squared magnitudes. But ∥yᵢ∥=∥hᵢ∥, ∀Pᵢ (because unitary matrices preserve the norm), and thereby combining the channel energies always results in a channel energy peak regardless of Pᵢ, \tilde{P}ᵢ. This, in turn, leads to an ambiguity. The pilot symbols cannot assist in resolving the ambiguity, and the only solution is to actually proceed and decode the messages of all BSs' that have produced a peak during application of various carrier offset correction values. In other words, unitary pilot matrices are not sufficient in aiding carrier synchronization with an intended BS (if several BSs have identical pilot placement up to a cyclic shift in the frequency domain, such as in Laroia et al.).

### CONCLUSION

In general, therefore, exemplary embodiments of the invention provide a method and apparatus for placing pilot symbols in a multicarrier MIMO system. In particular, in one exemplary embodiment, this involves the use of sets of multidimensional points whose structure is derived from discernible expansions of generalized orthogonal designs. These sets of multidimensional points can be used to form pilot symbols on a two-dimensional frequency-time pilot symbol grid that in turn can be used for sampling the flat fading processes on various subcarriers of an OFDM MIMO system, transmit antennas, and OFDM symbols.

Exemplary embodiments of the invention further provide a method and apparatus for using pilot information to perform initial carrier synchronization and OFDM symbol timing while discerning between candidate base stations.

Based on the foregoing description, as read in view of the appended drawing figures, it should be apparent that some examples of the invention relate to a method of placing pilots in a multicarrier MIMO system. In one exemplary embodiment, the method includes: (1) expanding generalized orthogonal multidimensional constellations; and (2) using the sets of multidimensional points of the expanded generalized orthogonal multidimensional constellations for placing pilot symbols in the multicarrier MIMO system.

Some examples of the invention further relate to a method of using pilot information to perform initial carrier synchronization and OFDM symbol timing while discerning between candidate base stations. In one exemplary embodiment the method may include, on the transmitter side: (1) constructing a set of multidimensional pilot symbols starting from a generalized orthogonal design; (2) expanding it; (3) allocating each multidimensional symbol (a matrix) to a pilot tone (subcarrier); and (4) transmitting the matrix elements on the subcarrier from the various antennas, during various OFDM symbols. On the side of the receiver, the method may include performing a correlation operation with the known χ vectors. According to exemplary embodiments of the invention, no staggering is needed in the placement of a pilot symbol on its corresponding spatial (antenna) and temporal (OFDM symbol) grid.

Some examples of the invention relate to a system for placing pilot symbols in a multicarrier MIMO system, the system may include one or more base stations in communication with one or more mobile stations, wherein the base stations transmit data including one or more pilot symbols to the respective mobile stations. In one exemplary embodiment, the base station comprises a transmitter that is capable of using sets of multidimensional constellation points having a structure that is derived from expanded generalized orthogonal multidimensional constellations for the placement of the pilot symbols. In another exemplary embodiment, the mobile stations comprise respective receivers for receiving data from the base stations, wherein the data includes one or more pilot symbols placed using the expanded generalized orthogonal multidimensional constellation.

Another example of the invention relates to a base station that is capable of placing pilot symbols in a multicarrier MIMO system. In one exemplary embodiment, the base station includes a means for expanding generalized orthogonal multidimensional constellations, and a means for using the sets of multidimensional points of the expanded generalized orthogonal multidimensional constellations for placing pilot symbols in the multicarrier MIMO system.

Examples of the invention further relate to a computer program product for placing pilot symbols in a multicarrier MIMO system. In one exemplary embodiment, the computer program product includes at least one computer-readable storage medium having computer-readable program code portions stored therein. These computer-readable program code portions may include, for example, a first executable portion for expanding generalized orthogonal multidimensional constellations; and a second executable portion for using the sets of multidimensional points of the expanded generalized orthogonal multidimensional constellations for placing pilot symbols in the multicarrier MIMO system.

Examples of the invention further relate to a computer program product for using pilot information to perform initial carrier synchronization and OFDM symbol timing while discerning between candidate base stations. In one exemplary embodiment, the computer program product includes at least one computer-readable storage medium having computer-readable program code portions stored therein.

As described above and as will be appreciated by one skilled in the art, embodiments of the invention may be configured as a system, method, mobile terminal device or other apparatus, or computer program product. Accordingly, embodiments of the invention may be comprised of various means including entirely of hardware, entirely of software, or any combination of software and hardware. Furthermore, embodiments of the invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of placing one or more pilot symbols in a multicarrier multiple-input multiple-output (MIMO) system, said method comprising:
constructing an orthogonal multidimensional constellation comprising a set of multidimensional constellation points; and
forming a pilot symbol from the orthogonal multidimensional constellation, said pilot symbol comprising a set of pilot points corresponding with the set of multidimensional constellation points.

2. The method of claim 1 further comprising:
expanding the orthogonal multidimensional constellation in order to increase the number of pilot points in the set of pilot points of the pilot symbol.

3. The method of claim 2, wherein the structure of the orthogonal multidimensional constellation and the expanded orthogonal multidimensional constellation is invariant to flat fading.

4. The method of claim 2, wherein the pilot symbol resides on a hypersphere.

5. The method of claim 2, wherein the pilot symbol comprises a matrix having one or more rows and one or more columns, and wherein respective rows of the matrix correspond with a separate antenna, said method further comprising:
transmitting the pilot points associated with a row of the matrix from the corresponding antenna.

6. The method of claim 5, wherein transmitting the pilot points associated with a row comprises transmitting respective pilot points during a separate orthogonal frequency division multiplexing (OFDM) symbol.

7. The method of claim 2 further comprising:
transmitting the set of pilot points of the pilot symbol from one or more antennas during one or more orthogonal frequency division multiplexing (OFDM) symbols, wherein, upon receipt, the pilot points are capable of being used to perform an initial carrier synchronization and OFDM symbol timing while discerning between one or more candidate base stations.

8. An apparatus for placing one or more pilot symbols in a multicarrier multiple-input multiple-output (MIMO) system, said apparatus comprising:
a pilot tone generator configured to generate and interleave one or more pilot tones for carrying a respective one or more pilot symbols, wherein respective pilot symbols are formed from an expanded orthogonal multidimensional constellation and comprise a set of pilot points corresponding with a set of constellation points of the expanded orthogonal multidimensional constellation.

9. The apparatus of claim 8 further comprising:
one or more antennas configured to transmit the pilot symbols, wherein respective pilot symbols comprise a matrix having one or more rows and one or more columns, and wherein respective rows of the matrix correspond with one of the one or more antennas.

10. The apparatus of claim 9, wherein transmitting the pilot symbols comprises transmitting the pilot points associated with respective rows of the matrix from the corresponding antennas.

11. The apparatus of claim 10, wherein transmitting the pilot points associated with respective rows comprises transmitting respective pilot points during a separate orthogonal frequency division multiplexing (OFDM) symbol.

12. A mobile station comprising:
a receiver configured to receive a pilot symbol, wherein the pilot symbol is formed from an orthogonal multidimensional constellation, said pilot symbol comprising a set of pilot points corresponding with a set of multidimensional constellation points of the orthogonal multidimensional constellation.

13. The mobile station of claim 12, wherein the receiver is further configured to receive a pilot symbol formed from an expanded orthogonal multidimensional constellation.

14. The mobile station of claim 13, wherein the structure of the orthogonal multidimensional constellation and the expanded orthogonal multidimensional constellation is invariant to flat fading.

15. The mobile station of claim 13, wherein the receiver comprises one or more antennas, and wherein receiving a pilot symbol comprises receiving the set of pilot points via the one or more antennas and during one or more orthogonal frequency division multiplexing (OFDM) symbols.

16. The mobile station of claim 15 further comprising:
a synchronizer configured to use the pilot symbol received to perform an initial carrier synchronization and OFDM symbol timing.

17. A system for transmitting one or more pilot symbols, said system comprising:
a base station configured to generate and transmit one or more pilot symbols, wherein respective pilot symbols are formed from an orthogonal multidimensional constellation; and
a mobile station configured to receive the one or more pilot symbols.

18. The system of claim 17, wherein respective pilot symbols comprise a set of pilot points corresponding with a set of constellation points of the orthogonal multidimensional constellation.

19. The system of claim 18, wherein the base station is further configured to construct the orthogonal multidimensional constellation and to form the pilot symbol from the orthogonal multidimensional constellation constructed.

20. The system of claim 19, wherein the base station is further configured to expand the orthogonal multidimensional constellation constructed in order to increase the number of pilot points in the set of pilot points of the pilot symbol.

21. The system of claim 18, wherein transmitting the pilot symbol comprises transmitting the set of pilot points over one or more antennas and in one or more orthogonal frequency division multiplexing (OFDM) symbols.

22. The system of claim 21, wherein the mobile station is further configured to use the pilot symbols received to perform initial carrier synchronization and OFDM symbol timing.

23. A computer program product for placing one or more pilot symbols in a multicarrier multiple-input multiple-output (MIMO) system, wherein the computer program product comprises at least one computer-readable storage medium having computer-readable program code portions stored therein, the computer-readable program code portions comprising:
a first executable portion for constructing an orthogonal multidimensional constellation comprising a set of multidimensional constellation points; and
a second executable portion for forming a pilot symbol from the orthogonal multidimensional constellation, said pilot symbol comprising a set of pilot points corresponding with the set of multidimensional constellation points.

24. The computer program product of claim 23, wherein the computer-readable program code portions further comprise:
a third executable portion for expanding the orthogonal multidimensional constellation in order to increase the number of pilot points in the set of pilot points of the pilot symbol.

25. The computer program product of claim 24, wherein the structure of the orthogonal multidimensional constellation and the expanded orthogonal multidimensional constellation is invariant to flat fading.

26. The computer program product of claim 24, wherein the computer-readable program code portions further comprise:
a fourth executable portion for transmitting the set of pilot points of the pilot symbol from one or more antennas during one or more orthogonal frequency division multiplexing (OFDM) symbols, wherein, upon receipt, the pilot points are capable of being used to perform an initial carrier synchronization and OFDM symbol timing while discerning between one or more candidate base stations.

27. An integrated circuit assembly for placing one or more pilot symbols in a multicarrier multiple-input multiple-output (MIMO) system, said integrated circuit assembly comprising:
a first logic element for constructing an orthogonal multidimensional constellation comprising a set of multidimensional constellation points; and
a second logic element for forming a pilot symbol from the orthogonal multidimensional constellation, said pilot symbol comprising a set of pilot points corresponding with the set of multidimensional constellation points.

28. The integrated circuit assembly of claim 27 further comprising:
a third logic element for expanding the orthogonal multidimensional constellation in order to increase the number of pilot points in the set of pilot points of the pilot symbol.

29. The integrated circuit assembly of claim 28, wherein the structure of the orthogonal multidimensional constellation and the expanded orthogonal multidimensional constellation is invariant to flat fading.

30. The integrated circuit assembly of claim 28 further comprising:
a fourth logic element for transmitting the set of pilot points of the pilot symbol from one or more antennas during one or more orthogonal frequency division multiplexing (OFDM) symbols, wherein, upon receipt, the pilot points are capable of being used to perform an initial carrier synchronization and OFDM symbol timing while discerning between one or more candidate base stations.
